(19) United States
(12) Patent Application Publication
(10) Pub. No.: US 2015/0249670 A1
(43) Pub. Date: Sep. 3, 2015

(54) SYSTEM, METHOD AND APPARATUS FOR COMMUNICATION ELIMINATION

(71) Applicant: Wiper Inc., New York, NY (US)

(72) Inventors: Michael Choupak, London (GB); Jason Fleitz, Brooklyn, NY (US); Manlio Carelli, New York, NY (US)

(73) Assignee: Wiper Inc., New York, NY (US)

(21) Appl. No.: 14/636,123

(22) Filed: Mar. 2, 2015

Related U.S. Application Data
(60) Provisional application No. 61/946,118, filed on Feb. 28, 2014.

(51) Int. Cl. H04L 29/06

(52) U.S. Cl. CPC H04L 63/10; H04L 63/20

(57) ABSTRACT

The present invention is directed to a system, method, procedure, device and apparatus for eliminating, erasing or wiping exchanged data or information from at least two devices, eliminating or wiping user exchanges of messages, whether text messages, photos, files, audio, video, file attachments, receipt information, communication records, and combinations thereof. Users with an agreed wipe protocol can initiate the wipe of all sensitive or confidential information by engaging a wipe command, which wipes the entire data or information exchange from the parties sharing same.

### CROSS REFERENCE TO RELATED APPLICATION

The present invention is a non-provisional of and claims priority from U.S. Provisional Patent Application Ser. No. 61/946,118, filed Feb. 28, 2014, now expired, entitled “SYSTEM, METHOD AND APPARATUS FOR COMMUNICATION ELIMINATION,” the subject matter of which is incorporated by reference herein.

### BACKGROUND OF THE INVENTION

1. Field of the Invention

The present invention is in the technical field of wiping or erasing communications, messages, data and information within an electronic communications system.

2. Description of Related Art

A fact of modern life is the permanence of information. In the past, in order to maintain privacy, one could physically destroy one's paper letters and other private communications. Now, in an age of digital mobile communications over global networks, the preservation of privacy, especially with respect to digital communications and their associated data, is more difficult than ever. The increasing variety of forms of communication, whether email and attachments, text, Twitter tweets, web postings, video, voice, etc., are often physically stored in their entirety and kept for future analysis by multiple third-party organizations long after the individual has logically deleted his or her personal copies of those communications.

Given the use of the Internet, social media and other shared environments, private information is more likely to become known, especially since the data, even data designated as confidential data, may be stored or otherwise shared across multiple client and server devices. As a result, there is an increasing need to insure that an individual's electronic communications remain private, regardless of the form or forms those communications may take.

One context where private communications could be problematic is in litigation discovery, where private or confidential exchanges could undermine a lawsuit. For example, in the Microsoft antitrust litigations, candid emails from Bill Gates where discovered and used at trial.

Several methodologies for combating this problem are available in the market, although each has serious flaws in its design. For example, Confide, Tiger Text, Wikr and other products are out there, but each has serious limitations and is not readily useful. Further, these prior art techniques do not give the user direct control over their own data and their exchanges over their own device, and do not extend to other devices, servers and such.

There is, therefore, a need to provide an easy-to-use tool, procedure and technique for use on a device or system, enabling a user or users to prevent the storage of confidential or other information exchanges or data by placing the eliminating of personal communications under control of the user or users.

### SUMMARY OF THE INVENTION

The present invention is directed to systems, methods, procedures, devices and apparatuses for eliminating or wiping user exchanges of messages, whether text messages, photos, files, audio, video, file attachments, receipt information, communication records, and combinations thereof.

### BRIEF DESCRIPTION OF THE DRAWINGS

While the specification concludes with claims particularly pointing out and distinctly claiming the subject matter that is regarded as forming the present invention, it is believed that the invention will be better understood from the following Detailed Description, taken in conjunction with the accompanying Drawings, where like reference numerals designate like structural and other elements, in which:

FIG. 1 illustrates an exemplary configuration of an electronic communication, and the wiping functionality of the present invention in a first embodiment;

FIG. 2A illustrates another exemplary configuration of the wiping functionality pursuant to the teachings of the present invention; and

FIG. 2B further illustrates the exemplary configuration of FIG. 2A.

### DETAILED DESCRIPTION OF THE INVENTION

The present invention will now be described more fully hereinafter with reference to the accompanying Drawings, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

As indicated, the instant invention is directed to systems, methods and apparatuses for a user or users to control the removing or eliminating of electronic communications between individuals, groups, etc.

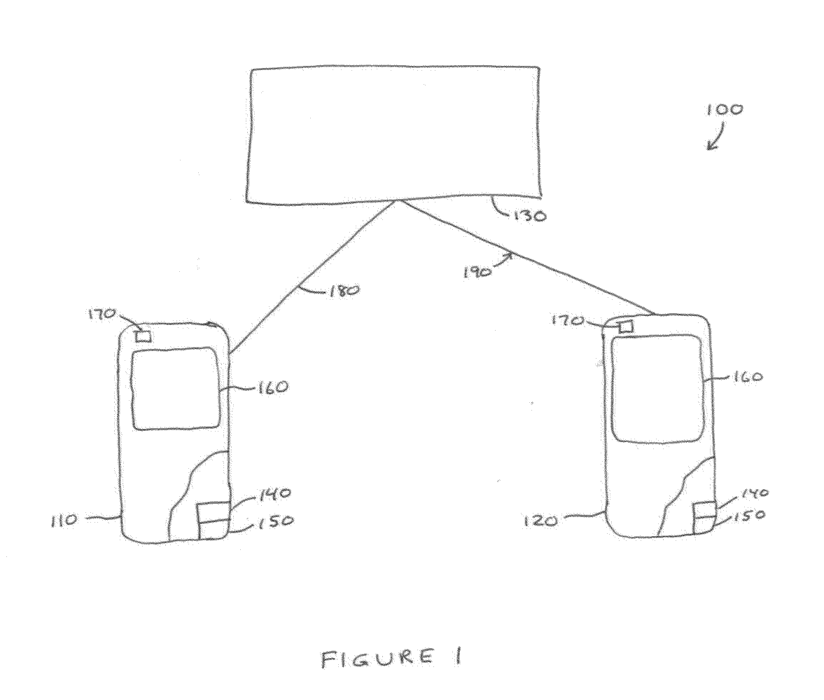

With reference to FIG. 1 of the DRAWINGS, there is illustrated an embodiment of the present invention, depicting an exemplary telecommunications or communications system, generally designated by the reference numeral 100. As shown, a first user of a first device, generally designated by the reference numeral 110, communicates with a second user of a second device, generally designated by the reference numeral 120. As is well known in the art, there may be a number of network and intermediary devices, routers, switches, servers and related equipment between the two users, connecting them for purposes of communication. An exemplary of these intermediary systems is generally designated by the reference numeral 130.

With further reference to FIG. 1, the first device 110, which could be a personal computer, a personal digital assistant (PDA), smart phone, cell phone or other communications device, has a processor, generally designated by the reference numeral 140, and a memory, generally designated by the reference numeral 150. Similarly, the second device has a processor 140 and memory 150.

In an exemplary operation, the first and second users exchange information or data, perhaps confidential or sensitive information or data, which passes through the server 130, but which is not stored on the server (or any other intermediary devices). Instead, in this embodiment, a shared client/server architecture, the data exchange and information are only stored locally within the memories 150 of the two devices. It should, of course, be understood that storage on the server 130 or any number of other intermediary devices, whether temporary or longer, may be present and constitutes another embodiment of the present invention discussed further hereinbelow.

To eliminate or wipe the confidential or other information, the two users (or groups of users) must agree to a wipe protocol. In this first embodiment of the present invention, this facility is best effectuated in a shared client/server architecture system, where all messaging or data exchanging is contained. However, the principles of the present invention may also be employed in other configurations between users or groups of users sharing and adhering to a wipe protocol between themselves. Alternate paradigms of operation are contemplated herein as well.

With reference again to FIG. 1 of the DRAWINGS, the first user of the first device 110 requests that a communication, message or entire thread or chain of messages be wiped, eliminated or erased from the system 100. This may be accomplished either by selecting a wipe command on a display, generally designated by the reference numeral 160, on the user's device 110, which may be touch screen, or by pressing a dedicated wipe button or other feature on the user's device 110, which could be virtual (on the display 160) or on hardware, e.g., a dedicated wipe button, generally designated by the reference numeral 170.

Upon the first user initiating the wipe functionality, whether on the display 160 or pressing the wipe button 170, the device 110 sends a command, generally designated by the reference numeral 180, whether wireline or wireless, to the server 130, with the instruction to delete some shared data or information, e.g., all messages between the first and second users older than the last message visible to the first user 110, or perhaps only a particular subset of interchanged messages, such as an email or Tweet exchange. It should be understood that the time stamp and its associated message-id is unique to a message across all participating systems, software and devices. The unique nature of the time stamp and its association with a specific message prevents new messages from the second user and the second user's associated device 120 being wiped before they are delivered to the first user's device 110. It should be understood that the wipe instruction may take the form of Java Script Object Notation (JSON), XML or other data interchange format, as is understood in the art. The instruction preferably includes an identification (ID) of the second user (or chat partner) 120, and the ID of the last message to be removed.

With further reference to FIG. 1, the second user's device 120, receives a notification, generally designated by the reference numeral 190, whether wireline or wireless, from the server 130 regarding the aforementioned wipe instruction 180 from the first user device 110. Upon receipt of the wipe command, the device 120 (under processor 140 control) deletes, eliminates or wipes all of the messages received from the first user that are older than the received message ID, including those resident in memory 150. If the two users are in an active chat session, the second user 120 sees an animated indication of the messages being wiped on display 160. Likewise, the first user 110 sees an indication on the display 160 that the particular messages stored on the second device 120 were wiped.

As noted in the first embodiment, the messages or information exchanged may reside on the server (or any number of other intermediary devices) only for the time period required for delivery, and then immediately and automatically removed. The aforementioned user actions to remove then involve only the two devices 110 and 120. However, in another embodiment of the present invention, the aforedescribed messages or information exchanged may also lie resident within the server 130, as well as perhaps a number of the aforesaid intermediary devices. Similar purging or erasing, as discussed hereinabove, is done within the memory components of the server 130 or any other intermediary devices, such as routers and switches, based on the aforesaid message identifications. It should be understood that such messages and information exchanged need not be permanently stored on these devices and are often subject to storage limitations, e.g., the stored data may be subject to automatic removal from the server(s) after a set time period, such as three days.

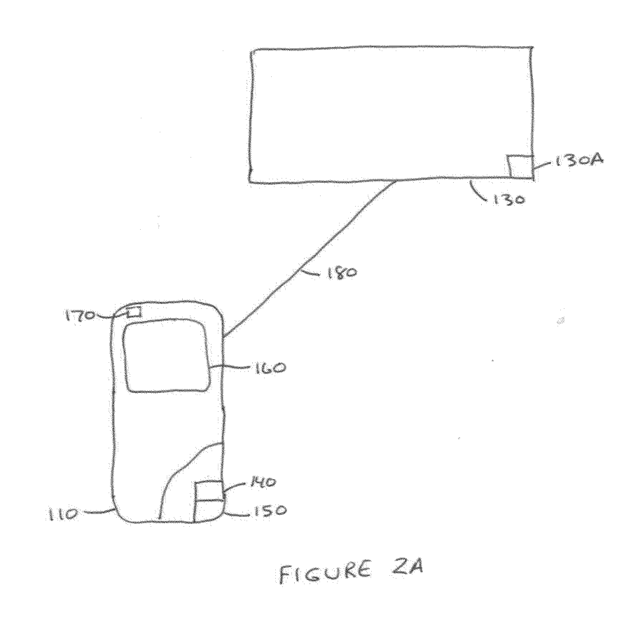

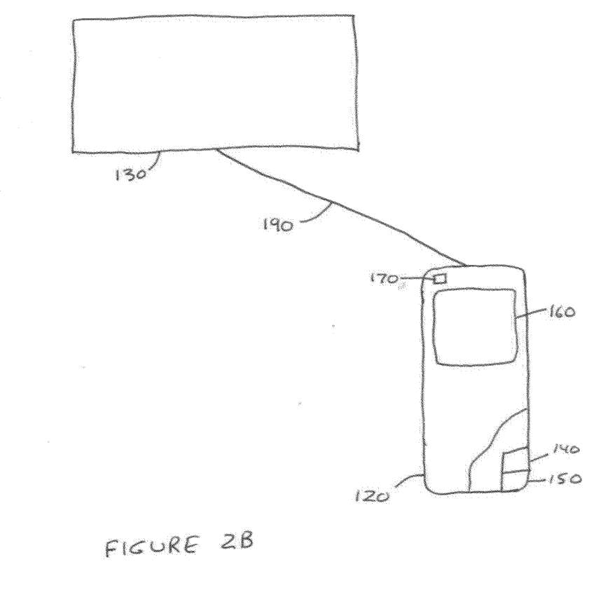

With reference now to FIG. 2A of the DRAWINGS, there is illustrated another embodiment of the present invention. Whereas the first embodiment illustrated the situation where both users were online, i.e., on the system simultaneously, this second embodiment illustrates a situation where the remote party, i.e., the second user 120, is offline.

As with the first embodiment, the first user initiates the wipe command from the first device 110, sending the wipe command 180 with the instructions to the server 130, such as from the display 160 or a dedicated wipe button 170, as described hereinabove. The first user may receive an indication from the server 130 that the wipe command is being transmitted to the second user, which is displayed on the display 160. Since, however, the second user is offline, the server 130 stores the instructions in a local memory, generally designated by the reference numeral 130A, with the requisite user identifications and time stamp indication, i.e., to delete all messages older than the last message. As discussed in the context of the second embodiment of the present invention, other intermediary devices may also store this data. Nonetheless, the wipe command of the present invention preferably wipes all instances except the one necessary to later accomplish the notification to the second user. It should also be understood that the wipe command on these intermediary devices may be held in abeyance until confirmation of the content elimination on the second device 120, at which point the intermediary device memories, such as 130A, are wiped.

With reference now to FIG. 2B of the DRAWINGS, there are illustrated the activities and functionalities when the second device 120 comes online in the system 100. At that point, the server 130 notifies the second device 120 of any updates, such as here the initiation of a wipe command by the first user. The second device 120 receives the information, which is stored by the server 130 in memory 130A, including the identification ID of the first user or partner that sent the wipe command, along with the corresponding message ID and time stamp information, as discussed hereinabove.

Based upon the user ID and the last message ID, the second device 120 then removes all of the messages or exchanges from the resident memory 150 pertaining to the first user or partner that are older than the received wipe message. Likewise, the data stored in server memory 130A, as well as any intermediary devices, is erased, and a message is sent to the first user of same. In this manner, the desired confidential or sensitive information between the parties stored on both devices, as well as intermediary devices, is erased or wiped. An indication of the wipe of the second device 120 is also sent to the first device, and displayed on the display 160 or monitor.

Through the techniques of the instant invention, illustrated in the various embodiments herein, various forms of exchanges can be protected and various types of information and data including but not limited to text messages, photos, audio and/or video content, and other files and attachments exchanged, receipt information, and numerous other content and data are permanently deleted, rendering entire conversation streams wiped with no trace of the conversation or associated content. In this fashion, compromising or sensitive information can be eliminated, making this tool useful to doctors, lawyers and others who exchange sensitive information that should be removed as soon as possible. The instant invention provides an easy-to-use paradigm and tool to perform this critical operation.

To add additional security, the present invention preferably employs encryption to assure that the data is unreadable by third-parties.

Although the illustrated embodiments show two-party communications, it should be understood that the same principles apply in multi-party instances, e.g., a team of people discussing a sensitive topic later erasing all instances of the electronic conversation and data exchanges from the system, with the requisite syncing of the users and messages.

With reference again to FIG. 1 of the DRAWINGS, there is illustrated another embodiment of the present invention. In this alternate embodiment, the first user 110 implements an “automatic wipe” policy using the wipe command option, which is available as an icon on a display 160 or a dedicated wipe button 170, as discussed hereinabove. In one embodiment of the “automatic wipe” policy, the policy may be turned on and off as a result of a double-click of the display command 160 or the dedicated wipe button 170. It should, of course, be understood that his does not preclude other gestures or operations from being used to initiate an “automatic wipe” policy.

Following the selection of an automatic wipe policy, only that user's last message will be maintained in the shared communications between the user sending the message 110 and the user (or users) receiving the message at device 120 (and perhaps other devices). At the initialization of the “automatic wipe” selection, the first user's device 110 sends a command, such as the aforementioned command 180, to the server 130 with the instruction to delete all messages older than the last message visible to the first user 110. The information identifying the message or messages to be wiped preferably includes the user ID, the message ID and the time stamp associated with the last message visible to the first user 110. This information is communicated to the second user's device 120 and to all other participating systems, software and devices.

With further reference to FIG. 1, the second user's device 120 receives a notification, such as the aforementioned notification 190, from the server 130, regarding the aforementioned wipe instruction 180 from the first user 110. Upon receipt of the wipe command, the device 120 deletes, eliminates or wipes all of the messages received from the first user that are older than the received message ID, including those resident in memory 150. If the two users are in an active chat session, the second user 120 sees an animated indication of the messages being wiped on display 160. Likewise, the first user 110 sees an indication on the display 160 that the particular messages stored on the second device 120 were wiped.

With further reference to FIG. 1, following the initialization of the “automatic wipe” policy, each successive message sent by the first user 110 to the second user 120 results in the sending of a command 180 by the first user's device 110 to the server 130 with the instruction to delete all messages older than the last message visible to the first user 110. This command 180 is communicated to the second user's device 120 and to all other participating systems, software and devices. The result is the immediate deletion of the previous message or messages sent by a user 110 from all devices in the telecommunications or communications system 100 each time a new message is added by the user 110. In this manner, the system 100 maintains only the last message from each user participating in the “automatic wipe” feature.

While the foregoing written description of the invention enables one of ordinary skill to make and use what is considered presently to be the best mode thereof, it should be understood that various changes, substitutions and alterations can be made herein without departing from the spirit and scope of the invention, as defined by the appended claims. Therefore, the invention is not to be limited by the above described embodiment, method, and examples, but by all embodiments and methods within the scope and spirit of the invention as claimed.

We claim:

1. A system facilitating data elimination comprising:
at least a first and a second device in communication through at least one intermediary device, at least one communication between a first user of the first device and a second user of the second device resident in said first and second devices; and
a wipe command, initiated by the first user on said first device, is forwarded to said second device through said intermediary device,
said at least one communication within said first and second devices being erased pursuant to said wipe command.

2. The system according to claim 1, wherein said at least one communication is content selected from the group consisting of: text messages, photos, files, audio, video, file attachments, receipt information, communication records, and combinations thereof.

3. The system according to claim 1, wherein said at least one communication is a confidential communication.

4. The system according to claim 1, wherein said at least one communication is an encrypted communication.

5. The system according to claim 1, wherein said wipe command is forwarded to at least one other device.

6. The system according to claim 5, wherein said wipe command is forwarded from said second device to said at least one other device, said at least one communication being erased from a memory of said at least one other device.

7. The system according to claim 1, wherein said wipe command resides within a memory of said intermediary device.

8. The system according to claim 7, wherein said wipe command resides within a plurality of memories of a plurality of intermediary devices.

9. The system according to claim 7, wherein said wipe command resides in said memory of said intermediary device when said second device is not active, and
wherein, upon activation of said second device, said wipe command is forwarded to said second device.

10. The system according to claim 7, wherein said at least one communication resides on said memory of said intermediary device, said wipe command removing said at least one communication from said memory of said intermediary device.

11. A device facilitating data elimination comprising:
a wipe command, said wipe command, after initiation by a user of said device, removes at least one communication from a memory therein, and identifies at least one other device within which said at least one communication resides; and
a transceiver, said transceiver forwarding said wipe command to said at least one other device,
wherein, at said at least one other device, said at least one communication is erased pursuant to said wipe command received at said second device.

12. The system according to claim 11, wherein said at least one communication is content selected from the group consisting of: text messages, photos, files, audio, video, file attachments, receipt information, communication records, and combinations thereof.

13. The device according to claim 11, further comprising:
a wipe button, wherein pressing said wipe button initiates said wipe command.

14. The device according to claim 11, further comprising:
a display, wherein a user of said device initiates said wipe command

15. The device according to claim 14, wherein said display is a touchscreen display, said user pressing an icon on said display to initiate said wipe command.

16. The device according to claim 11, wherein said at least one communication is a confidential communication.

17. The device according to claim 11, wherein said at least one communication is an encrypted communication.

18. A method for facilitating data elimination comprising:
initiating, by a first user of a first device, a wipe command to erase at least one communication between said first user and at least one other user of at least one other device;
erasing said at least one communication within a memory of said first device; and
transmitting said wipe command to said at least one other device,
wherein, at said at least one other device, said at least one communication is erased pursuant to said wipe command.
